(19) United States
(12) Patent Application Publication
(10) Pub. No.: US 2011/0004498 A1
(43) Pub. Date: Jan. 6, 2011

(54) Method and System for Identification By A Cardholder of Credit Card Fraud

(75) Inventor: Neil Ian Readshaw, Parkwood (AU)

Correspondence Address: IBM CORP. (DHJ);c/o DAVID H. JUDSON, 15950 DALLAS PARKWAY, SUITE 225, DALLAS, TX, 75248, US

(73) Assignee: International Business Machines Corporation, Armonk, NY (US)

(21) Appl. No.: 12/496,239

(22) Filed: Jul. 1, 2009

(51) Int. Cl. G06Q 40/00; G06Q 10/00

(52) U.S. Cl. 705/7; 705/44; 705/35

(57) ABSTRACT

A method for fraud detection leverages an existing financial institution's fraud classification functionality, which produces a first level detection, with a “user-centric” classification functionality, which produces a “second” or more fine-grained detection regarding a potentially fraudulent transaction. After passing through an existing (“institution-centric”) fraud detection technique, a transaction that has been identified as potentially fraudulent is then subject to further analysis and classification at the “user” level, as it is the user is presumed to be the best source of knowledge of the legitimate credit card use. Information about the transaction is shared with the consumer, preferably via one or more near real-time mechanisms, such as SMS, email, or the like. Based on the user's response (or lack thereof, as the case may be), one or more business rules in the institution's fraud detection system can then take an appropriate action (e.g., no action, reverse the transaction if complete, deny the transaction if in-progress, or the like).

### BACKGROUND OF THE INVENTION

1. Technical Field

This disclosure relates generally to computer-implemented techniques for preventing credit card fraud and misuse.

2. Background of the Related Art

Credit card fraud (and identity fraud/theft) has a high cost in modern society. In response, financial institutions such as banks and credit card companies (such as Visa® and Mastercard®) are in a constant battle to reduce fraud to protect their brands and their profits. The majority of credit card fraud detection schemes employed by financial institutions today are based around centralized systems that look for anomalous transactions. The response to detecting what is believed to be an anomalous transaction is then determined by the financial institution, e.g., based on a set of risk profiles. Other known techniques use approaches such as predictive modeling, rules-based anomaly detection, or geographic or time-based use analysis to detect fraudulent transactions. In some system, the user may be notified of a transaction-in-progress so that the transaction can be approved.

A side-effect of any fraud detection method is the risk of false positives. For example, if a rule-based fraud detection system is too aggressive or unsuccessful in identifying valid transactions as fraudulent, the consumer may be unable to use his or her credit card when they need it most, e.g., during travel in a foreign country with limited financial alternatives. One response from financial institutions is to relax their rules in some ways for specific consumers, in which case the fraud detection systems consider almost all transactions valid by default. This kind of response, however, is too coarse-grained to still provide effective fraud detection.

### BRIEF SUMMARY OF THE INVENTION

A method for fraud detection leverages an existing financial institution's fraud classification functionality, which produces a first level detection, with a “user-centric” classification functionality, which produces a “second” or more context-aware detection regarding a potentially fraudulent transaction. After passing through an existing (“institution-centric”) fraud detection technique, a transaction that has been identified as potentially fraudulent is then subject to further analysis and classification at the “user” level, as it is the user is presumed to be the best source of knowledge of the legitimate credit card use. Information about the transaction is shared with the consumer, preferably via one or more near real-time mechanisms, such as SMS, email, or the like. Based on the user's response (or lack thereof, as the case may be), one or more business rules in the institution's fraud detection system can then take an appropriate action (e.g., no action, reverse the transaction if complete, deny the transaction if in-progress, or the like).

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is an exemplary block diagram of a distributed data processing environment in which exemplary aspects of the illustrative embodiments may be implemented;

FIG. 2 is an exemplary block diagram of a data processing system in which exemplary aspects of the illustrative embodiments may be implemented;

FIG. 3 illustrates a conventional fraud detection mechanism used in a financial institution according to the known prior art;

FIG. 4 illustrates a fraud detection mechanism according to the teachings of this disclosure;

FIG. 5 illustrates a representative service provider infrastructure that can be shared by entities that use a fraud detection mechanism according to this disclosure;

FIG. 6 illustrates a representative text message sent to a mobile device to alert a cardholder of a potentially fraudulent transaction;

FIG. 7 illustrates a representative web page sent to a mobile device to alert a cardholder of a potentially fraudulent transaction and to request a confirmation; and

FIG. 8 illustrates a representative audit log generated by a financial institution's fraud detection service that operates according to the teachings described herein.

### DETAILED DESCRIPTION OF AN ILLUSTRATIVE EMBODIMENT

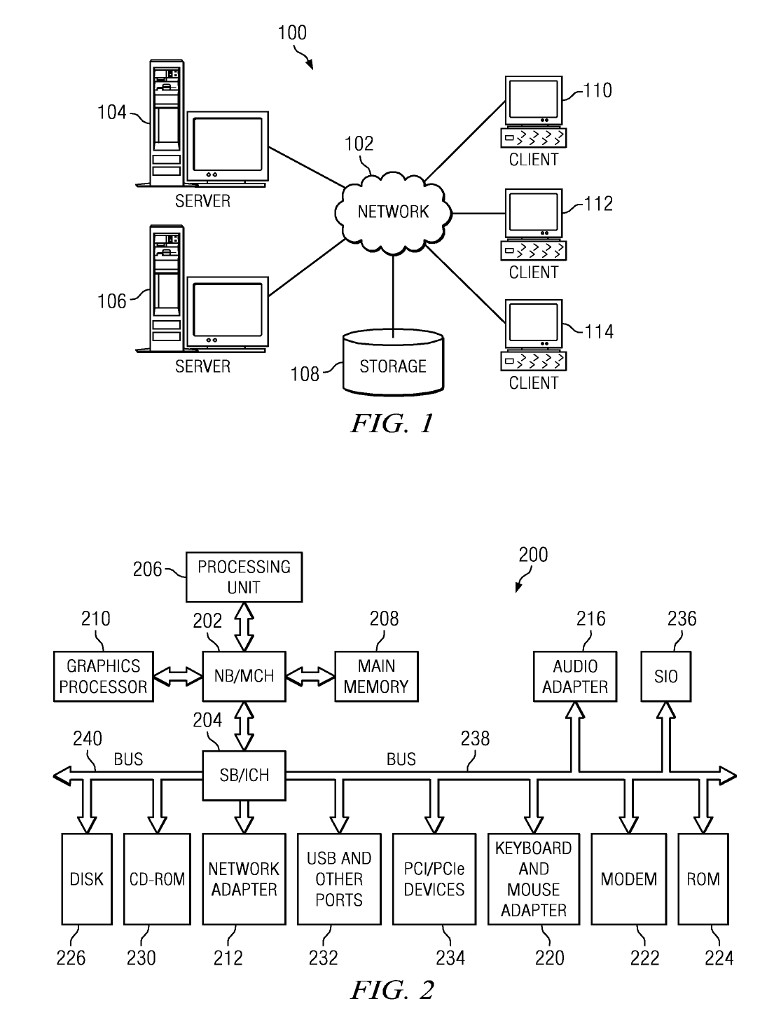

With reference now to the drawings and in particular with reference to FIGS. 1-2, exemplary diagrams of data processing environments are provided in which illustrative embodiments of the disclosure may be implemented. It should be appreciated that FIGS. 1-2 are only exemplary and are not intended to assert or imply any limitation with regard to the environments in which aspects or embodiments of the disclosed subject matter may be implemented. Many modifications to the depicted environments may be made without departing from the spirit and scope of the present invention.

With reference now to the drawings, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the disclosed subject matter, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the disclosure may be located.

In the depicted example, data processing system 200 employs a hub architecture including bridge and memory controller hub (NB/MCH) 202 and bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java and all Java-based trademarks and logos are trademarks of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system. IBM, AIX, eServer, MQSeries, and system P are trademarks or registered trademarks of International Business Machines Corporation in the United States, other countries, or both. LINUX is a registered trademark of Linus Torvalds in the United States, other countries, or both. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the disclosure may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the disclosed subject matter.

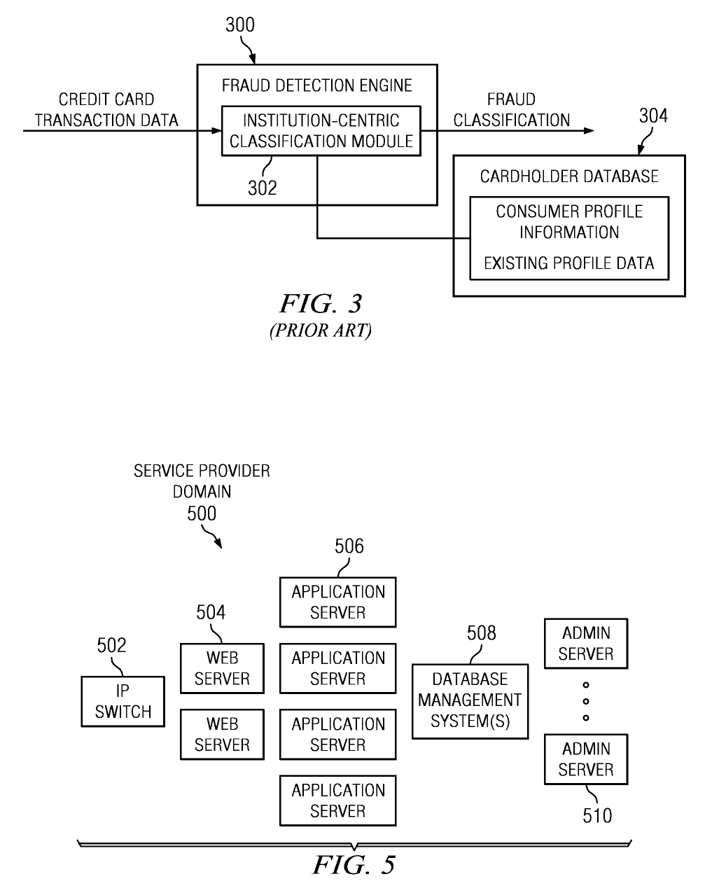

FIG. 3 illustrates a conventional fraud detection mechanism used in a financial institution according to the known prior art. As used herein, the term “financial institution” should be broadly construed to refer to banks, conventional credit card companies (such as Visa, Mastercard, American Express®, Discover®, etc.), affiliate card companies, commercial entities, transaction processing entities, and the like. A transaction processing facility comprises data processing systems and devices such as described above with respect to FIGS. 1-2. Of course, the fraud detection systems typically comprise many software applications and utilities, and the representation shown in FIG. 3 has been simplified for discussion and illustration purposes. The conventional fraud detection approach comprises a fraud detection engine 300 that includes “institution-centric” classification module 302, which is typically implemented in software executing on one or more processing devices. The institution-centric classification module 302 obtains pertinent data about a cardholder from a cardholder database 304, which includes consumer profile information for authorized cardholders. In operation, the institution's fraud detection engine 300 generates an assessment of the fraudulent nature of the credit card transaction data that is shown as an input. Based on the classification metrics imposed by the classification module 302, and using the consumer profile information retrieved from the database 304, the detection engine outputs a fraud classification for each transaction supplied to the system. While these known approaches typically work well for their intended purpose, there is a need to provide more context-aware fraud detection.

The fraud detection engine in FIG. 3 may be considered a particular machine for analyzing and classifying credit card transactions. The techniques for implementing the fraud detection engine are quite varied, and the techniques described herein are not intended to rely upon any particular mechanism. Some financial institutions build their fraud systems as a custom application that interfaces to core credit systems. In other cases, a custom application is built for business rules management. Off-the-shelf systems that provide business rules management and that can be used for these purposes include ILOG JRules, which allows business rules to be invoked from application code using an application programming interface (API). Using JRules (or the like), fraud rules can be written and externalized from a calling application.

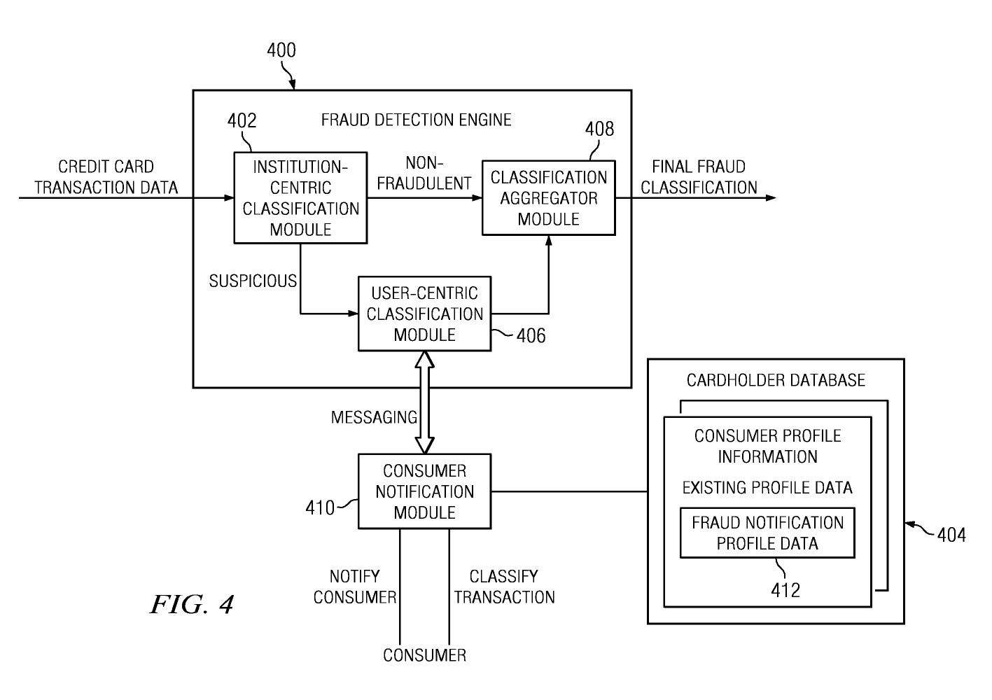

FIG. 4 illustrates the basic concept of the subject matter of the present disclosure that enables identification of credit card fraud by a cardholders As with FIG. 3, the fraud detection entity comprises a fraud detection engine 400 having an institution-centric classification module 402, together with a cardholder database 404 that stores consumer profile information. As compared to FIG. 3, however, the system of this disclosure includes an additional set of modules in the fraud detection engine, which are shown in FIG. 4 as a “user-centric classification module” 406 together with a classification aggregator module 408. The system also includes a consumer notification module 410. The cardholder database also includes a new data type, namely, fraud notification profile data 412. Typically, the fraud notification profile data comprises as alias for each card number for each card associated with a card owner. The alias provides privacy protection so that the true credit card number is maintained private. Of course, the modules shown in FIG. 4 are shown as being discrete, but this is not a limitation of this disclosure. Any of the illustrated functions may be combined with some other functionality, or be built as an adjunct or complement to an existing function or feature. The following provides a description of how these additional modules operate in an illustrative embodiment.

The system may operate in real-time (or near real-time), such as when it is desired to detect possible fraud during an actual credit card transaction, or it may be carried out “after-the-fact” on historical transaction data. As illustrated in FIG. 4, the “credit card transaction data” is shown as an input, and one of ordinary skill in the art will understand that such data may be provided in any convenient manner. The data may be provided for a single transaction, or multiple transactions may be processed in bulk. The financial transaction's institution-centric classification module 402 executes on the received data to generate an initial assessment of the fraudulent nature of the transaction under consideration. This classification is based on information already known by the institution, together with one or more business rules that enforce policies. If the existing institution-centric transaction classification determines that the transaction is not fraudulent, the additional modules shown in the fraud detection engine do not provide further processing. If, however, the institution-centric classification module 402 considers that the transaction may be fraudulent (or suspects it to be so within a configurable tolerance), the transaction is output to the user-centric classification module 406 for further processing. In response to receipt of a suspect transaction, the user-centric classification module 406 creates an entry in a state table for this transaction and then sends a notification request to the consumer notification module 410. The notification request may be provided in any convenient manner, such as via a messaging protocol (e.g., SOAP/XML Web services, Java Messaging Service, IBM MQ, or the like). Preferably, the notification request comprises information about the transaction under investigation such as, without limitation: the date and time of the transaction, a merchant identifier for the transaction, an amount of the transaction, the card number used (or desired to be used) for the transaction. In response, the consumer notification module 410 retrieves the notification, performs a lookup into the cardholder database 404 against the fraud notification profile data 412 for the owner of the card identified in the transaction data, and retrieves the card “alias.” Preferably, the consumer notification module 410 then notifies the consumer of the potentially fraudulent transaction. The mechanism used to send the notification preferably is near-real-time, such as a short message service (SMS) message, an e-mail, an MMS, a link to a web page, or the like. Preferably, the notification comprises the following information: the date and time of the transaction, information identifying the merchant, the amount of the transaction, the alias for the card number used in the transaction, and information (an invitation) about how to respond to the notification.

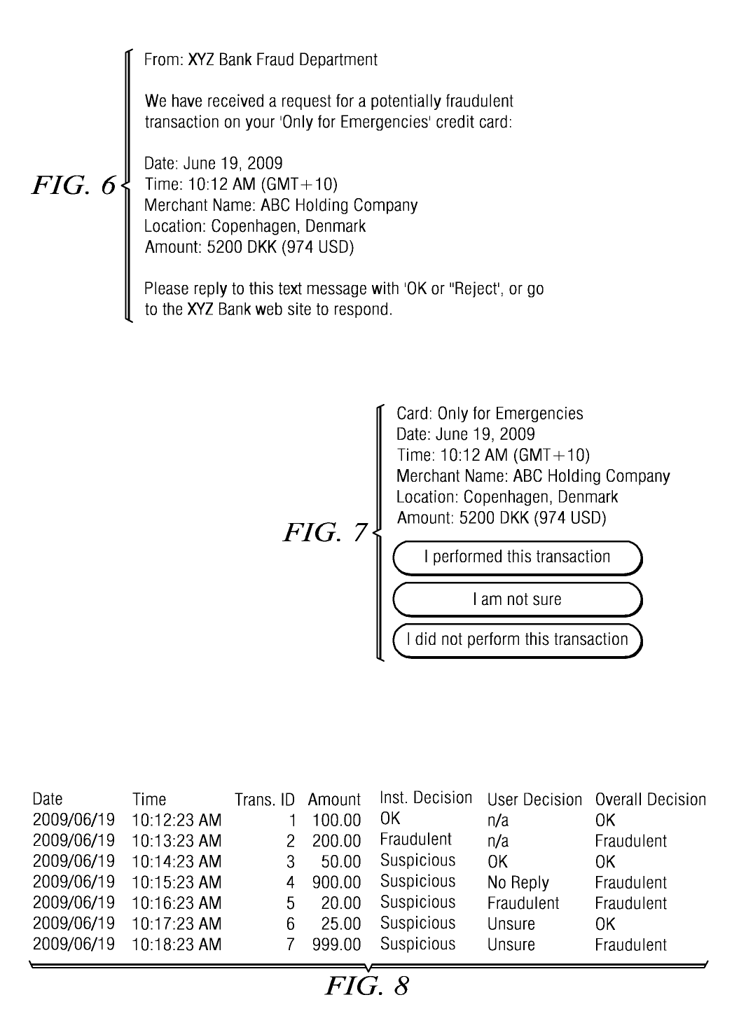

FIG. 6 illustrates a representative text message sent to a mobile device to alert a cardholder of a potentially fraudulent transaction.

The consumer, having received the notification, examines it and makes a determination regarding an appropriate response. According to this disclosure, the decision (about whether to respond, and how to respond), however, is based on information (status, geographic location, movements, spending habits, online activity, and the like) that is unique or specific to the cardholder himself or herself. This information is in contrast to the “institution-centric” data that informs that initial coarse-grained decision enforced by the institution-centric classification module. This “user-centric” information is information that the financial institution is not otherwise aware of (or, if it is, the institution is not aware of its then-specific context) given the user's then-current status, location, activity, situation, and the like.

The consumer then responds to the notification in one or more ways. In one embodiment, the consumer responds via an SMS, an email, an MMS, via a Web application, by return telephone call, or the like. Possible responses states to the notification may be quite varied, such as: the transaction is definitely valid, the transaction is definitely fraudulent, the transaction may be fraudulent but more information is needed, etc. FIG. 7 illustrates a representative web page sent to a mobile device (such as a Blackberry device, an iPhone device, or the like) to alert a cardholder of a potentially fraudulent transaction, and to request that the cardholder provide a confirmation regarding that transaction. In this example, the various response options may be color-coded to provide additional visual cues. Upon receiving the response from the consumer, the consumer notification module 410 relays it back to the user-centric classification module 406. The user-centric classification module may be implemented with a configurable time value to wait for the response; if the response is received within the time value, processing continues. If the response is received outside the time window, this “no response” may be used to augment the possible notification response states, or the delayed response may be used as an indication that the transaction is fraudulent depending on some other business rule or policy. Having received a valid and timely response, the user-centric classification module 406 then passes the response to the classification aggregator module 408. The aggregator module 408 implements business logic (one or more business rules, policies, or the like) to produce the final fraud classification. For example, the financial institution may choose to allow the transaction when the user confirms that it is not fraudulent, or if the user is unsure, but deny transactions when the user confirms the transaction as fraudulent or did not respond in a timely manner. This enables the financial institution to retain ultimate control of its own fraud-detection business process.

The fraud detection engine 400 shown in FIG. 4 may be considered a fraud detection machine, which is a particular or specialized machine used to carry out the fraud detection methods of this disclosure.

The disclosed subject matter provides significant advantages. The technique improves on and complements existing methods of automated credit card fraud detection that involve an institution-centric view of a consumer and the transactions initiated with the consumer's credit card. The disclosed technique achieves this and other advantages by leveraging the consumer's direct knowledge of the legitimate use of his or her own credit card for transactions identified (by the institution initially) as potentially fraudulent. Preferably, as noted above, the consumer is actively engaged in verifying his or her transaction(s), and such verification may be accomplished during an actual transaction (a transaction-in-progress) or after-the-fact based on historical data. A benefit of this approach to the financial institution is that is can more accurately and rapidly identify fraudulent transactions. A benefit to the consumer is that he or she can play an active role in identifying misuse of his or her financial identity. In addition, a consumer benefits when he or she identifies a transaction that has been falsely identified as fraudulent and would otherwise have the potential to result in the cancellation and re-issuance of his or her credit card, which can be burdensome and time-consuming. This approach enables a consumer to use his or her card on a more widespread (e.g., geographically-speaking) basis without the accompanying fear that the user's account will be misused or compromised.

As noted above, preferably the disclosed technique integrates connectivity to consumers into a financial institution's existing fraud detection system, although this is not a limitation of the invention. After passing through existing fraud detection techniques (including, without limitation, the institution-centric classification module), information about a transaction that appears fraudulent can be shared with consumers, preferably via one or more real-time, near-real-time or other than real-time mechanisms, for feedback on the transaction (e.g., whether the consumer believes it to be fraudulent). Based on the response (or lack thereof) from the consumer, one or more business rules in the institution's fraud detection system take an appropriate action, as has been described above.

The functionality described above may be implemented within or as an adjunct to any existing or later-developed institution-based fraud detection approach. The disclosed technique is not limited to any particular type of fraud detection engine, or any particular type of institution-centric classification module. Also, the term “institution-centric” classification module should be broadly construed to refer to any existing or later-developed techniques, functions, systems, devices, processes, programs, utilities or the like that are implemented with an “institution-centric” approach to the consumer's financial transactions and data. As noted above, an “institution-centric” approach is a technique, an approach, a metric or the like that is general in nature in that it may apply to many consumers, or to the individual consumer across multiple contexts. In contrast, the “user-centric” approach implemented by the user-centric classification module 406 is tailored to provide what can be described as context-specific data. The use of user-centric (as opposed to institution-centric) analysis provides for much stronger transaction verification and much more dynamic fraud detection as compared to the prior art (such as shown in FIG. 3). Indeed, the decision about whether a particular transaction is or is not fraudulent is carried out within a specific context that is preferably known only by the user (or by others trusted thereby). Preferably, the user-centric classification approach does not involve information or data that is configured in advance, and preferably only the consumer knows or has in mind the particular context of the transaction that will influence the ultimate fraud detection determination.

The institutional-centric classification module may be considered a “coarse-grained” classification, whereas the user-centric classification module may be considered a “context-aware” classification. These descriptions, however, should not be deemed to limit the subject disclosure. More generally, the institutional approach may be considered a “first” classification, whereas the user-centric approach is a “second” classification.

The functionality described above (including, e.g., the user-centric classification module, the consumer notification module and the classification aggregator module, may be implemented as a standalone approach, e.g., a software-based function executed by a processor, or it may be available as a managed service (including as a Web Service via a SOAP/XML). FIG. 5 illustrates one such “managed” or hosted service so that it can be shared. In this embodiment, which is preferably Internet-based, an end user of the managed service (e.g., a financial institution) has an Internet-accessible machine. Typically, the financial institution user (directly or programmatically), such as an administrator, accesses the service provider architecture by opening a web browser on the machine to a URL associated with a service provider domain or sub-domain. The user (once again, either directly or programmatically) then authenticates to the managed service in the usual manner, e.g., by entry of a username and password. The connection between the machine and the service provider infrastructure may be secure, but need not be. Although connectivity via the publicly-routed Internet is typical, the user may connect to the service provider infrastructure over any local area, wide area, wireless, wired, private or other dedicated network. As seen in FIG. 5, the service provider architecture 500 comprises an IP switch 502, a set of one or more web server machines 504, a set of one more application server machines 506, a database management system and repository 508, and a set of one or more administration server machines 510. A representative web server machine 504 comprises commodity hardware (e.g., Intel-based), an operating system such as Linux, and a web server such as Apache 2.x. A representative application server machine 506 comprises commodity hardware, Linux, and an application server. The database management system and repository 508 may be implemented using any conventional database management package. In a high volume use environment, there may be several web server machines, several application server machines, and a number of administrative server machines. Although not shown in detail, the infrastructure may include a firewall, a name service, other load balancing appliances, caches, other switches, network attached storage, and the like. Each machine in the system typically comprises sufficient disk and memory, as well as input and output devices. Generally, the web servers 504 handle incoming requests and provide responses in the usual form, e.g., web pages. The application servers 506 manage the data and facilitate the functions of the fraud detection platform. The administrator servers 510 handle all back-end accounting and reporting functions. The particular hardware and software implementation details described herein are merely for illustrative purposes are not meant to limit the scope of the described subject matter.

FIG. 8 illustrates a representative audit log generated by a financial institution's fraud detection service (such as shown in FIG. 5) that operates according to the teachings described herein. This audit log is generated from a fraud detection system after integrating the user-centric classification described herein. As can be seen, different overall decisions are provided based on the differences between the institution-centric and user-centric classifications. The last two lines illustrate a low value suspicious transaction that has been permitted whereas a high value suspicious transaction has been considered to be fraudulent.

An end user (a financial institution customer) has a mobile device or other Web client. That device preferably interoperates with the consumer notification module shown in FIG. 4. The user-centric classification module, the consumer notification module, and the classification aggregator module run as applications in one or more application servers 906, and the cardholder database is located within (or is otherwise accessible to) the infrastructure.

There is no limitation as to the particular techniques that may be used by an end user consumer. Moreover, the term “consumer” should not be construed as limiting. The client-to-server communication may be over a local area network, a wide area network, or any other network, or over a telecommunications network that involves text, voice, data or the like.

More generally, computing devices within the context of the disclosed invention are each a data processing system (such as shown in FIG. 2) comprising hardware and software, and these entities communicate with one another over a network, such as the Internet, an intranet, an extranet, a private network, or any other communications medium or link. The applications on the data processing system provide native support for Web and other known services and protocols including, without limitation, support for HTTP, FTP, SMTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP, FTP, SMTP and XML is available from Internet Engineering Task Force (IETF). Familiarity with these known standards and protocols is presumed.

The fraud detection scheme described herein may be implemented in or in conjunction with various server-side architectures including simple n-tier architectures, web portals, federated systems, and the like.

The techniques described herein are not limited for use with credit cards. In particular, the disclosed techniques may also be used with other types of cards or financials instruments including, without limitation, debit cards prepaid cards, affinity cards, checks, negotiable instruments, and the like. Also, as used herein, the term “card” should be broadly construed to cover both the physical card, as well as the card “account” associated therewith.

Also, the techniques described herein may also be used for any type of identity verification, and not just credit card transactions. Moreover, the term “transaction” should be broadly construed to include any event, transaction, action or activity associated with a permitted user's card or card account, as the case may be.

Still more generally, the subject matter described herein can take the form of an entirely hardware embodiment, an entirely software embodiment or an embodiment containing both hardware and software elements. In a preferred embodiment, the function is implemented in software, which includes but is not limited to firmware, resident software, microcode, and the like. Furthermore, as noted above, the invention can take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device. The medium can be an electronic, magnetic, optical, electromagnetic, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. The computer-readable medium is a tangible item.

The computer program product may be a product having program instructions (or program code) to implement one or more of the described functions. Those instructions or code may be stored in a computer readable storage medium in a data processing system after being downloaded over a network from a remote data processing system. Or, those instructions or code may be stored in a computer readable storage medium in a server data processing system and adapted to be downloaded over a network to a remote data processing system for use in a computer readable storage medium within the remote system.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Also, the term “web site” or “service provider site” should be broadly construed to cover a web site (a set of linked web pages), a domain at a given web site or server, a trust domain associated with a server or set of servers, or the like. A “service provider domain” may include a web site or a portion of a web site. Any application or functionality described herein may be implemented as native code, by providing hooks into another application, by facilitating use of the mechanism as a plug-in, by linking to the mechanism, and the like.

Having described my invention, what I now claim is as follows.

What is claimed is:

1. A method of classifying a transaction involving a card associated with an authorized user, comprising:
receiving transaction data associated with the card at a detection machine;
determining whether the transaction data represents a potentially suspect transaction associated with the card;
if the transaction data represents a potentially suspect transaction, issuing a notification to the authorized user that requests confirmation of the potentially suspect transaction;
determining whether a response to the notification has been received from the authorized user, where the response is based on information that is known to the authorized user and is context-specific to the authorized user; and
based on the response, classifying the transaction data.

2. The method as described in claim 1 wherein determining whether the transaction data represents a potentially suspect transaction occurs during the transaction.

3. The method as described in claim 1 wherein determining whether the transaction data represents a potentially suspect transaction occurs following the transaction.

4. The method as described in claim 1 wherein determining whether the transaction data represents a potentially suspect transaction analyzes the transaction data using a first classification module.

5. The method as described in claim 4 wherein the first classification module is an institution-centric classification module.

6. The method as described in claim 1 wherein the notification is issued in real-time, or near real-time.

7. The method as described in claim 1 further including determining whether the response to the notification has been received within a configurable time period.

8. The method as described in claim 7 wherein if the response to the notification has not been received with the configurable time period, classifying the transaction data as representing a suspect transaction.

9. The method as described in claim 1 wherein the card is a credit card.

10. The method as described in claim 1 wherein the notification is issued via one of: a text message, an email, and a web application.

11. The method as described in claim 10 wherein the notification includes an alias for an account number.

12. The method as described in claim 11 wherein the notification includes a date and time of the transaction, an amount of the transaction, a merchant identifier, and the alias.

13. The method as described in claim 1 wherein the response to the notification is one of: a valid transaction, a fraudulent transaction, an uncertain transaction, and no response.

14. A data processing system, comprising:
a processor;
computer memory holding computer instructions for carrying out a fraud detection method comprising:
receiving transaction data associated with a credit card;
determining whether the transaction data represents a potentially suspect transaction associated with the credit card;
if the transaction data represents a potentially suspect transaction, issuing a notification to an authorized user that requests confirmation of the potentially suspect transaction;
determining whether a response to the notification has been received from the authorized user, where the response is based on information that is known to the authorized user and is context-specific to the authorized user; and
based on the response, classifying the transaction data.

15. The data processing system as described in claim 14 wherein determining whether the transaction data represents a potentially suspect transaction occurs during the transaction or after the transaction.

16. The data processing system as described in claim 14 wherein transaction data represents a potentially suspect transaction analyzes the transaction data using a first classification module.

17. The data processing system as described in claim 14 wherein the notification is issued in real-time, or near real-time.

18. The data processing system as described in claim 14 wherein the response to the notification is one of: a valid transaction, a fraudulent transaction, an uncertain transaction, and no response.

19. A computer program product for use in a data processing system comprising a computer-readable medium holding instructions that when executed by a processor direct a fraud detection mechanism to:
receive an indication of a potentially suspect transaction associated with a card;
issuing a notification to the authorized user that requests confirmation of the potentially suspect transaction;
determining whether a response to the notification has been received from the authorized user, where the response is based on information that is known to the authorized user and is context-specific to the authorized user; and
based on the response, classifying the transaction data.

20. The computer program product as described in claim 19 wherein determining whether the transaction data represents a potentially suspect transaction occurs during a card transaction, or after a card transaction.

21. The computer program product as described in claim 19 wherein the notification is issued in real-time, or near real-time.

22. The computer program product as described in claim 19 wherein the response to the notification is one of: a valid transaction, a fraudulent transaction, an uncertain transaction, and no response.

23. Apparatus for fraud detection, comprising:
a processor;
computer program memory holding computer instructions for directing a fraud detection mechanism to:
receive an indication of a potentially suspect transaction associated with a card;
issuing a notification to the authorized user that requests confirmation of the potentially suspect transaction;
determining whether a response to the notification has been received from the authorized user, where the response is based on information that is known to the authorized user and is context-specific to the authorized user; and
based on the response, classifying the transaction data.
